(19) United States
(12) Patent Application Publication
(10) Pub. No.: US 2015/0197975 A1
(43) Pub. Date: Jul. 16, 2015

(54) HEAT ENERGY MANAGEMENT IN BUILDINGS

(71) Applicant: VKR Holding A/S, Horsholm (DK)

(72) Inventors: Bjarne Ravndal Andreasen, Struer (DK); Jacob Heldgaard Thomsen, Herning (DK)

(21) Appl. No.: 14/595,709

(22) Filed: Jan. 13, 2015

Related U.S. Application Data
(60) Provisional application No. 61/927,228, filed on Jan. 14, 2014.

(51) Int. Cl. E05F 15/70; G05B 15/02; E06B 7/28

(52) U.S. Cl. CPC E05F 15/70; E06B 7/28; G05B 15/02

(57) ABSTRACT

A method of operating a system for operating one or more adjustable window related devices, the system including one or more controllable units associated with the one or more adjustable window related device, and at least one data input unit, where the controllable unit operates the adjustable window related device according to an obligatory control scenario, where the obligatory control scenario includes one or more rules, and where at least one of the one or more rules are based on input from the data input unit, where the system provides heat energy management in a building (3) in which the adjustable window related device is arranged by adjusting the adjustable window related device according to the obligatory control scenario, and where the obligatory control scenario is temporarily at least partly overruled based on user initiated actions.

### CROSS REFERENCE TO RELATED APPLICATION

This application is related to and claims the benefit of U.S. Provisional Patent Application Ser. No. 61/927,228 filed on 14 Jan. 2014, the contents of which are herein incorporated by reference in their entirety.

### TECHNICAL FIELD

The present invention relates in a first aspect to a method of operating a system, in a second aspect a system for operating an adjustable window related device, and in a third aspect a method of improving heat energy management of a building.

### BACKGROUND

Energy optimization in buildings have in the recent years become more and more important to protect the environment and to reduce costs in relation to heating and/or cooling rooms of buildings.

For example, some lawmakers have focused more and more on adjusting laws relating to building regulations to try to provide more energy efficient buildings by increasing the demands to for example the degree of insulation of new buildings.

Also, improved insulation materials for buildings have been developed, and the insulation properties of windows are continuously improved to provide windows with improved insulation properties.

However, buildings may still suffer from limitations and/or drawbacks in relation providing more energy efficient buildings.

The present invention e.g. relates to providing a solution that may improve heat energy management of buildings.

### BRIEF SUMMARY

The invention relates to a method of operating a system for operating one or more adjustable window related devices, wherein said system comprises:
one or more controllable units associated with said one or more adjustable window related device, and
at least one data input unit,

wherein said one or more controllable units operates said adjustable window related device according to an obligatory control scenario,

wherein said obligatory control scenario comprises one or more rules, and wherein at least one of said one or more rules are based on input from said data input unit,

wherein said system provides heat energy management in a building in which said adjustable window related device is arranged by adjusting said adjustable window related device according to said obligatory control scenario, and

wherein said obligatory control scenario is temporarily at least partly overruled based on user initiated actions.

A significant control of the indoor temperature in a building may be provided by opening and closing windows and/or by adjusting screening devices such as blinds, shutters or awnings to adjust the amount of sunlight entering the related window, and/or to improve the degree of insulation of the building by screening the windows. Thus, by controlling such devices, heat energy management of the building may be enhanced.

By providing the obligatory control scenario, ordinary users such as visitors or occupants of the building may not be able to fully disable the obligatory control scenario. Thus, the system may provide heat energy management in the building by adjusting the adjustable window related device according to the obligatory control scenario. Since the control scenario is obligatory, the user may e.g. operate a remote control, and/or a technician may temporarily overrule the obligatory control scenario to provide another control of the respective device. However, this is only temporary and the overruling will thus after an amount of time, e.g. controlled by a timer functionality or other criteria, be removed to provide the operation according to the obligatory control scenario again. Thus, the adjustable window related device(s) will over time be operated according to the obligatory control scenario whereby an enhanced optimization of the heat energy management in the building may be provided since the obligatory control scenario may only temporarily be overruled.

The obligatory control scenario is preferably mandatory/obligatory in the sense that it may not be possible to disable it permanently by the end user employing the end user user-interface. Hence, the end user user-interface such as control panel or remote control may not provide for permanent disablement of the obligatory control scenario at least in an obvious manner. In aspects of the invention, it may be possible to permanently disable an obligatory control scenario, but in such aspects, confidential manufacturer information (e.g. a safety code) other or safety precautions may preferably be necessary to use to be able to disable the obligatory control scenario permanently.

The rule(s) of the obligatory control scenario(s) may describe what may or may not be allowed in a particular situation, and the scenario(s) may thus provide a description of what could or should happen in a given situation based on e.g. parameters from a data processing unit. The parameter(s) received from data input unit(s) such as a sensor or the like may thus represent criterion(s) for the rules. For example if a measured room temperature is above a predefined target temperature then a window should be opened, a blind should be adjusted to cover the window and/or the like.

The system may moreover, in aspects of the invention e.g. be in communication with a temperature adjustment system such as a heating system or cooling system, and a data input unit may hence in aspects of the invention be a part of such a heating or cooling system. For example, if a cooling system of the building starts up to lower a temperature a room, the obligatory control scenario may be provided with this information and based thereon e.g. close window(s), provide further screening by adjustable screening devices and/or the like. The same may e.g. be applied if a heating system of the building starts to heat a room of a building. If a heating system such as a stove, district heating system or the like starts to heat a room, the obligatory control scenario may receive this information and thus close windows, expose the windows to maximum sunlight by moving an adjustable screening device to a non-screening position and/or the like.

The overruling of the obligatory control scenario may in an aspect comprise that the obligatory control scenario may be executed/processed without implementing the prescribed setting(s) of one or more window related device(s), if it has been operated due to a user initiated action. Hence, the prescribed setting given by an obligatory control scenario for a window related device may first be set according to the obligatory control scenario when the user initiated action is removed by a timer function and/or if other criteria are complied with. This is described in more details later on.

The overruling of the obligatory control scenario may also in an aspect of the invention, comprise that the obligatory control scenario is temporarily disabled due to a user initiated action. Hence, the obligatory control scenario is first started up for that window related device when the user initiated action is removed by a timer function and/or if other criteria are complied with.

The above mentioned user initiated actions may comprise one or more actions initiated by a user of the system by means of e.g. a user controllable control device, an input from a presence detection arrangement such as a sensor (such as a movement sensor) for e.g. detecting the presence of one or more persons in a room of the building and/or the like. The user initiated actions may for example be provided actively by a user in the sense that the user by hand (by e.g. a remote control), speech, sign or other possible input may at least partly overrule an obligatory control scenario. In other aspects, the user may e.g. passively provide a user initiated action by e.g. entering a room or an area relating to the building, Hereby, the location of the user may be detected, and an at least partly overruling may be provided obligatory control scenario.

It is understood that in aspects of the invention, an obligatory control scenario may provide heat energy management to one or more adjustable window related devices while an obligatory control scenario relating to other adjustable window related devices is temporarily, at least partly overruled. Hence, a user may e.g. open a window, thereby temporarily overruling prescriptions of an obligatory control scenario relating to that window, but an obligatory control scenario may still provide heat energy management to e.g. an awning and/or a blind providing screening features to the window while the user setting regarding the opening of the window still applies.

In aspects of the invention, said system may comprise a user controllable control device, such as a remote control, and said obligatory control scenario may be temporarily at least partly overruled due to user input provided by means of said user controllable control device.

As an example, a screening device such as a blind may be moved to a substantially full-closed position at night to prevent heat energy provided by e.g. a temperature adjustment system of the building from leaving the building since the fully closed screening device may provide additional insulation. Such a temperature adjustment system may e.g. comprise a heating system of the building for raising the temperature of one or more rooms of the building compared to the temperature outside the building by means of e.g. an electric heater, by a gas, oil and/or wood furnace, by district heating, and/or the like. The temperature adjustment system may as previously mentioned also or alternatively comprise a cooling system such as an air-conditioning system of the building for lowering the indoor temperature of one or more rooms of the building compared to the outside of the building. However, while the screening device is fully closed due to the obligatory control scenario, a user may wish to look out of the respective window, and may hence, e.g. by means of a remote control, (e.g.) roll up the blind by means of a button control arrangement, a remote control, manually and/or the like to look out the window, thereby temporarily overruling the obligatory control scenario. However, since the overruling will only be temporary, the system will, e.g. when a timer functionality expires, remove the overruling so that the system again operates according to the obligatory control scenario and thus moves the blind to the full-closed position to provide insulation.

As another example, during day, the system may try to prevent or at least reduce the need of air-conditioning cooling in the building. Thus, if for example a high temperature is registered inside the building, and/or the sun is detected to shine (e.g. input from the input data unit), the obligatory control scenario may provide that an awning is unwinded/extended so that sunlight is prevented from entering the window associated with the awning. However, a user may wish to overrule this to provide e.g. an increased view through the window, and the user may e.g. retract the awning by operating a remote control or the like. Thus, the obligatory control scenario will be temporarily overruled, but when predefined criteria are complied with (e.g. by a timer functionality or other criteria), the obligatory control scenario may again e.g. extend the awning according to the obligatory control scenario if the temperature in the room is still too high according to the rules of the obligatory control scenario.

In aspects of the invention, said obligatory control scenario may be temporarily at least partly overruled if predefined safety criteria are violated, and said system may enable said obligatory control scenario when said predefined safety criteria are fulfilled.

This may e.g. provide a system where the system, even though it is operated according to an obligatory control scenario, may still assure safety so that the safety of persons is not at risk due to emergency situations such as e.g. fire. This may prevent that persons get stuck due to that e.g. the obligatory control scenario adjust an adjustable window related device to a position where it is made more complicated to leave the building.

In aspects of the invention, said controllable unit may be powered by battery, wherein said system comprises a battery indicator related to said battery, wherein said predefined safety criteria relates to an input from said battery indicator, and wherein said obligatory control scenario is temporarily overruled if said battery indicator provides an indication of low battery.

This may e.g. improve safety in the sense that enough power may be available in the system for e.g. operating the adjustable device(s) according to an emergency scenario, if a person is stuck, to close a window, move an awning to a non-screening position to assure that the awning is not damaged by high wind speeds, to close a window if it rains according to information from a rain sensor and/or the like.

In advantageous aspects of the invention, at least a part of said obligatory control scenario may be executed while it is overruled.

The rules of the obligatory control scenario may thus be executed to the extent that at least some parameters are still processed according to rules of the control scenario to determine if one or more adjustable window related devices should be adjusted to another setting compared to a previous setting that the obligatory control scenario prescribed. For example, the obligatory control scenario may prescribe that a window should be closed to e.g. improve heat gain. A user may then overrule this setting by opening a window 10%. However, the obligatory control scenario may still be executed at least partly so that if e.g. the obligatory control scenario later on finds that the window should be opened to e.g. 50% (while the user setting still applies), the obligatory control scenario may e.g. be re-introduced by discarding the user setting and hence provide heat energy management by adjusting the window to 50% as prescribed by the rules. Hence an improved heat energy management may be provided where user initiated actions may be complied with and at the same time, advantageous trigger conditions for reintroducing the control by the obligatory control scenario may be provided. The rules of the obligatory control scenario may thus help to provide criteria for determining when to return to operating according to the control scenario when a user initiated action is applied.

In aspects of the invention, said obligatory control scenario is re-introduced after being overruled if a setting of said adjustable window related device should be amended according to the rules of said obligatory control scenario, and wherein said setting is executed according to the rules of said obligatory control scenario.

This may e.g. provide that relevant and user friendly criteria for determining when to reintroduce the full operation of the obligatory control scenario so that the obligatory control scenario provides heat energy management may be used.

In advantageous aspects of the invention, said data input unit comprises a sensor such as a sunlight sensor and/or a temperature sensor.

This may e.g. provide improved heat energy management which takes into account climatic conditions inside and/or outside the building.

In aspects of the invention, said at least one data input unit may provide a time indication, e.g. based on a time schedule, and said heat energy management may then be configured to be based on said time indication.

This may provide a simple and yet efficient heat energy management control based on e.g. whether it is night or day, based on if it is a working day or not, based on whether persons are normally away or present in the building according to the schedule and/or the like. Hence, a screening device may e.g. be set to a covering position during night to improve insolation, and may automatically be set to e.g. a non-covering position at day to improve heat gain due to sunlight.

In aspects of the invention, said data input unit may be a temperature sensor for detecting the temperature in a room which a window is arranged to provide daylight to, said adjustable window related device may be associated with said window, said heat energy management may be based on a predefined target temperature for said room, and said heat energy management may comprise adjusting said adjustable window related device based on said target temperature and said temperature detected by means of said temperature sensor.

This may provide an effective and more advanced heat energy management that may e.g. provide a more user friendly and/or comfortable heat management.

In aspects of the invention, said overruling of said obligatory control scenario may be removed upon expiry of a timer function.

A timer function may provide an advantageous trigger for assuring that the overruling is removed, so that the system over time will provide the heat energy management. The timer may be a watchdog timer, it may be a timer which is started when the overruling is initiated and/or the like. The timer may also in aspects of the invention be provided together with a processing of e.g. rules of the obligatory control scenario during the overruling.

Said heat energy management may in advantageous aspects of the invention reduce heat gain in said building based on input from said at least one data input unit by adjusting one or more of said one or more adjustable window related device(s) according to said obligatory control scenario rules.

This may be provided by adjusting adjustable screening devices such as awnings, shutters, blinds or the like so as to decrease the amount of sunlight entering a room, e.g. if a room temperature is detected to be above a target temperature, if direct sunlight is detected to be provided to the room (e.g. detected by a daylight sensor) through a window and/or the like. It may also provide that windows are opened if the temperature outside a building is detected to be lower than a detected room temperature and/or a target temperature and/or the like. It may also comprise closing windows if the temperature outside the window is detected to be higher that a detected room temperature, a room target temperature and/or the like.

In aspects of the invention, said obligatory control scenario may increase heat gain in said building based on input from said at least one data input unit by adjusting one or more of said one or more adjustable window related device(s) according to said obligatory control scenario rules.

The heat gain may e.g. be provided by adjusting adjustable screening devices such as awnings, shutters, blinds or the like so as to increase the amount of sunlight entering a room, it may comprise assuring that windows are closed to prevent heat energy from leaving a room of the building and/or the like. It may also in aspects comprise opening a window if the temperature outside the building is measured by a data input unit to be higher than the temperature in a room of the building, to provide hotter air to the room. It may moreover comprise adjusting adjustable screening devices such as blinds and/or shutters or the like so as to increase the degree of insulation provided by a window arrangement, e.g. during night. It is understood that these examples may be combined in aspects of the invention.

In aspects of the invention, said window related device may be a screening device, and said obligatory control scenario rules may adjust said screening device to a screening position such as for example a substantially full screening position dependent on input from said at least one data input unit.

Adjusting screening devices to provide heat energy management has shown to be an effective way of adjusting heat energy in a building. The screening device may thus provide an increased insulation, it may reduce inflow of sunlight from windows, thereby reducing heat gain and/or the like.

A screening position may be understood as that the screening device is extended/rolled out, adjusted to a position where it may screen at least a part of the window. A substantially full screening position may be understood as that the screening device is adjusted to a position where it provide as much screening as possible to the window. If for example the screening device is a blind, it may be rolled out/extended so that it covers substantially the whole window, if it is an awning, it may be extended as much as possible and/or as much as is considered safe (e.g. based on input from a wind sensor) and/or the like. A screening device may also comprise a film coating on the window that may change transparency for sunlight according to a data input from e.g. a controllable unit.

In advantageous aspects of the invention, said obligatory control scenario may be factory pre-set and becomes active upon first power up of said system.

This provides a solution where it is more certain that the heat energy management provided by the obligatory control scenario is implemented in the system. Because the obligatory control scenario may hence work out-of-the-box energy savings provided by the obligatory control scenario are ensured. Thus there is no dependency on someone enabling the obligatory control scenario and preferably also no risk that an end user may disable the obligatory control scenario. By ensuring the energy savings a product with obligatory control scenario may thus fulfill a better energy rating than a product without the obligatory control scenario. The first power up may be understood as when the system comprising the obligatory control scenario is put into normal operation after being purchased, installed and possibly also configured to fit the respective building.

The obligatory control scenario may in aspects of the invention be implemented into an existing system by e.g. retrofitting it to one or more windows later on.

In advantageous aspects of the invention, said system may comprise a first and a second obligatory control scenario, wherein said first and second obligatory control scenario are both configured for acting as said obligatory control scenario, and wherein said system is configured so that one of said first and second control scenario is selected as said obligatory control scenario.

This may provide several advantages in relation to upgrading the system and/or in relation to assure heat energy management.

In advantageous aspects of the invention, said system may be configured so that a second obligatory control scenario takes over the heat energy management from a first obligatory control scenario.

The feature of providing different obligatory control scenarios may provide several advantages. The second obligatory control scenario may e.g. be more advanced than the first obligatory control scenario, and may e.g. be configured for providing the heat energy management based on parameters from a plurality of data input units and/or may be configured for controlling a plurality of adjustable units based on input from one or more data input units.

Hence, a user may e.g. purchase a system providing a basic heat energy management (by e.g. a first obligatory control scenario), but if e.g. a user purchases a plurality of adjustable units, and/or further data input units later on, it may be advantageous to be able to upgrade the heat management of the building by providing a further second obligatory control scenario.

In aspects of the invention, a second obligatory control scenario may take over the heat energy management from a first obligatory control scenario, wherein said takeover of said heat energy management is confirmed when predefined criteria are complied with, and wherein said first obligatory control scenario is reintroduced if said predefined criteria are not complied with.

This may e.g. provide a solution where it can be assured that a system may continuously be operated according to at least basic heat energy management provided by the first obligatory control scenario. So if a user for example for example upgrades the system and provides a more advanced second obligatory control scenario, but later on removes the upgrade (e.g. by providing a further remote control, a further data input unit and/or the like), and that this is later on removed again, the system will return to operate according to the basic control scenario again to assure that the system is provided with an active heat energy management system.

The mentioned predefined criteria may e.g. comprise a timer functionality where the system, when the timer expires, may detect whether the second obligatory control scenario should still take over the heat energy management or if the first obligatory control scenario should be reintroduced due to e.g. absence of the part of the system executing the second control scenario and/or the like. Additionally or alternatively, the first obligatory control scenario may e.g. be processed in the “background”, e.g. at the respective controllable unit or at another locations such as in a remote control or another component of the system. When the system detects that an adjustment of a device should be performed according to the first obligatory control scenario, the system may detect whether the second obligatory control scenario should still take over the control or if the first obligatory control scenario should be reintroduced due to e.g. absence of the part of the system executing the second control scenario and/or the like.

In aspects of the invention, said second control scenario may be associated with a further unit of said system, such as a remote control or another control unit of said system, and wherein said first obligatory control scenario is configured to be re-activated if said further unit is disabled, removed and/or in other ways made unavailable to the system.

Hence, a user may e.g. upgrade the system by providing a further unit to the system such as a new remote control and/or a further input unit. This unit may e.g. comprise a second further obligatory control scenario stored in a data storage of the unit, the second further obligatory control scenario may be downloaded from a server or the like. The second further obligatory control scenario may take over the heat energy management from the first obligatory control scenario, but if e.g. the further unit is removed from the system, runs out of battery or is in other ways made unavailable to the system, the system reactivates the first control scenario to assure that the system provides heat energy management.

The first control scenario may for example be arranged to base the heat energy management on input from a sun sensor or a timer functionality. A user may then provide a temperature sensor to the system, and the second control scenario may then base the operation on both the sun sensor and/or time functionality and the temperature sensor. But if the temperature sensor is made unavailable to the system later on, the system operates according to the first control scenario again.

In aspects of the invention, at least one of said one or more adjustable window related devices may comprise a controllable unit.

This may provide a more integrated and/or space saving solution where it is also provided that heat energy management is provided in aspects of the invention wherein the obligatory control scenario is stored and executed at the controllable unit.

In aspects of the invention, at least one of said one or more controllable units and the adjustable window related device associated with this controllable unit may be battery and/or solar energy powered.

This may e.g. provide a dynamic system which is easy to install and maintain. In aspects where the power is provided by solar energy, the system may comprise its own individual solar cell for providing electric energy based on energy from the sun. This may e.g. be connected to the controllable unit and/or another unit of the system.

In preferred aspects of the invention, said adjustable window related device is a screening device such as a blind, awning, roller, shutter, or film coating.

In other aspects, the window related device may be a window or a ventilation opening with a damper associated with the window such as in e.g. a frame part of said window.

In aspects of the invention, said obligatory control scenario may be stored in a data storage associated with a controllable unit.

The obligatory control scenario may thus e.g. be stored in a data storage accompanying the adjustable window related device, and/or it may be located together with the adjustable device itself. For example, the device may in embodiments of the invention be arranged so that the controllable unit is arranged together with and/or incorporated in the adjustable device, and moreover, a battery for powering the controllable unit may in aspects of the invention be arranged together with and/or incorporated in the adjustable device. The data storage comprising the obligatory control scenario may also in aspects of the invention also be incorporated with the adjustable window related device so that the obligatory control scenario is associated to the device already at delivery.

In further aspects of the invention, said system my comprise a plurality of data input units, and said obligatory control scenario may thus provide said heat energy management by adjusting said one or more window related device(s) according to input from said plurality of input units.

This e.g. provides a system that may be more efficiently controlled with regard to heat energy management, and/or it may provide a system that is more user friendly.

In advantageous aspects of the invention, said system may comprise a plurality of controllable units, wherein said controllable units are associated with different adjustable window related devices, and wherein said plurality of controllable units are operated according to an obligatory control scenario.

This may e.g. provide a system with improved heat energy management capabilities and adjustment possibilities with regard to providing a more comfortable heat energy management. For example, if the system comprises different types of devices such as an adjustable awning and a blind (associated with e.g. the same or different windows), the blind may be used at night to provide an improved insulation, and the awning may be used during the day to adjust the amount of sunlight entering the room without preventing a person in the building from looking through the window to the outside of the building. In other embodiments, the adjustable devices may also be of the same type.

In aspects of the invention, said controllable units my advantageously be controlled by a common obligatory control scenario.

This may provide a more efficient system with regard to heat energy management and/or a more user friendly system where e.g. synchronous operation of adjustable devices may be provided.

In aspects of the invention, said building may comprise a plurality of windows, and said different adjustable window related devices, may be associated to different windows of said plurality of windows.

This may provide a system that may provide a more efficient and/or user friendly heat energy management.

The windows may in aspects of the invention be arranged to provide daylight to the same room of the building, and the obligatory control scenario may e.g. be a common control scenario that control the adjustable devices of the plurality of windows to provide a common heat energy management to that room.

Advantageously said plurality of adjustable window related devices may in aspects of the invention be configured to be operated according to different firsts obligatory control scenarios.

This may e.g. be advantageous in that such a control may be independent and may thus provide a dynamic system that may be easy to adapt and amend.

In advantageous aspects of the invention, a second common obligatory control scenario may take over the heat energy management provided by said different firsts obligatory control scenarios, and wherein said different firsts obligatory control scenarios may be reintroduced if said second common obligatory control scenario is removed and/or if other criteria are not complied with.

Such other criteria may e.g. comprise that an input unit providing information to the second common obligatory control scenario is removed from the system, that the unit storing and handing the second common obligatory control scenario is removed/reset or the like. The above may e.g. provide a system where heat energy management may be provided continuously over time dependent on different configurations of the system.

In aspects of the invention a control by an obligatory control scenario may be overruled for one or more first adjustable window related devices due to an user initiated action, while one or more further adjustable window related devices are controlled according to an obligatory control scenario to provide said heat energy management while said overruling takes place.

This may e.g. become advantageous in a system for operating adjustable devices relating to different windows or the same window. For example, a user may operate a blind to look out a window (thereby overruling an obligatory control scenario) without that this may influent on heat energy management provided by other devices such as a blind relating to another window in e.g. the same room, an awning relating to the same or another window and/or the like. Hence, improved heat energy management may be provided by the system while (e.g. partly) overruling an obligatory control scenario.

In aspects of the invention, said obligatory control scenario may be configured to be disabled when predefined safety precautions are met. This may e.g. provide a more safe and reliable solution.

The invention moreover relates to a system for operating an adjustable window related device, wherein said system comprises:
at least one controllable unit for being associated with an adjustable window related device, and
at least one data input unit,

wherein said at least one controllable unit is configured to operate said adjustable window related device according to an obligatory control scenario,

wherein said obligatory control scenario comprises one or more rules, and wherein at least one of said one or more rules are based on input from said data input unit,

wherein said system is configured to provide heat energy management in a building in which said adjustable window related device is arranged by adjusting said adjustable window related device according to said obligatory control scenario, and

wherein said obligatory control scenario is configured to be temporarily at least partly overruled based on user initiated actions.

In advantageous aspects of said system, said system may comprises a plurality of data input units, and wherein said obligatory control scenario is configured to provide said heat energy management by adjusting said one or more window related device(s) according to data input from said plurality of input units.

In aspects of said system said system comprises a plurality of a controllable units, wherein said controllable units are configured to be associated with different adjustable window related devices, and wherein said plurality of controllable units are operated according to said obligatory control scenario.

Generally, it may be understood that the different adjustable window related devices may be of the same type (e.g. different windows) or of different types (e.g. windows, and different types of screening devices such as venetian blinds, shutters, film coatings, awnings and/or the like).

In advantageous aspects of said system, said plurality of controllable units may be configured to be controlled by a common obligatory control scenario.

In aspects of said system, said obligatory control scenario may be stored in a data storage associated with a controllable unit.

In aspects of said system, wherein said adjustable window related device may be a screening device such as a blind, awning, roller, shutter, or film coating.

In aspects of said system, at least one of said one or more adjustable window related devices may comprise a controllable unit.

In advantageous aspects of said system, said system comprises at least one user controllable control device, such as a remote control, and wherein said obligatory control scenario is configured to be temporarily at least partly overruled due to user input provided by means of said user controllable control device.

In aspects of said system, said system may be configured to operate in accordance with the method of any of claims 1-16.

According to an embodiment of the invention, the term “temporarily overruling” means that the automatic algorithm will fall back on the automatic routine at some point. Then the user may initiate further overruling only by manual user initiated actions, such as e.g. by activation of a user interface being part of said system or being in communication, preferably wireless communication, with said system.

According to an embodiment of the invention, said controllable unit may be any control unit which facilitates adjustment of one or more of said adjustable window related devices. In other words, the controllable unit or control unit operates one or more of said adjustable window related devices.

In aspects of said system, said obligatory control scenario is an automatic control algorithm.

In aspects of said system, said obligatory control scenario is temporarily and manually at least partly overruled based on user initiated actions.

In aspects of said system, the method is applied to obtain a tax advantage by automatically controlling one or more controllable units associated with said one or more adjustable window related devices.

Additionally, the invention relates to a method of improving heat energy management of a building, said method comprising:

providing a system according to any of claims 17-20 to said building, associating one or more controllable units of said system with one or more adjustable window related device(s), and

associating said one or more adjustable window related device with a window of said building so that said system is able to provide said heat energy management of a room of said building by adjusting said adjustable window related device according to said obligatory control scenario.

Additionally, the invention relates to a method of operating a system for operating one or more adjustable window related devices,

wherein said system comprises:
one or more controllable units associated with said one or more adjustable window related devices, and
at least one data input unit,

wherein said one or more controllable units operates said adjustable window related device according to an obligatory control scenario,

wherein said obligatory control scenario comprises one or more rules, said obligatory control scenario being an automatic control algorithm controlling said adjustable window related devices automatically over time,

and wherein at least one of said one or more rules are based on input from said data input unit,

wherein said system provides heat energy management in a building, in which said adjustable window related device is arranged, by said one or more controllable units operating said adjustable window related device according to said obligatory control scenario, and

wherein said obligatory control scenario is temporarily and manually overruled based on user initiated actions.

Additionally, the invention relates to a method of operating a system for operating one or more adjustable window related devices to obtain a tax advantage,

wherein said system comprises:
one or more controllable units associated with said one or more adjustable window related devices, and
at least one data input unit,

wherein said one or more controllable units operates said adjustable window related device according to an obligatory control scenario,

wherein said obligatory control scenario comprises one or more rules, and wherein at least one of said one or more rules are based on input from said data input unit,

wherein said system provides heat energy management in a building in which said adjustable window related device is arranged by adjusting said adjustable window related device according to said obligatory control scenario, and

wherein said obligatory control scenario is temporarily at least partly overruled based on user initiated actions.

and wherein the tax advantage is obtained through an improved degree of insulation with respect to heat transmission via a window associated with one or more of said adjustable window related device.

The tax advantage may e.g. include a tax reduction obtained through the automatic return to an obligatory control scenario when the system is not manually operated. A goal of the automatic return to an obligatory control scenario may basically be to ensure that the adjustable window related device may provide a maximum insulation until a user manually overrides this automatic maximum insulation. The maximum insulation is obtained though the fact that the system automatically returns to “normal” control routine insofar a user does not manually interfere.

It should be under stood that in some embodiments, it may actually be a goal, at least sometimes to reduce the degree of insulation, e.g. if the temperature in the room and/or building is too high and is cooled partly by an air conditioner in cooling mode, and adjusting the one or more window related devices may increase the heat flow out of the building, which reduces the need for the air conditioner.

It should be understood that the tax advantage may e.g. be a tax reduction.

Further to the above, the insulation may be against heat and/or against coldness.

The tax advantage may be associated with reducing the costs for heating and/or cooling of the particular building in which the one or more window related device(s) are installed, or at least a part thereof, such as e.g. an apartment.

The tax advantage may be associated with the particular adjustable window related device, or with a window associated with one or more of such adjustable window related devices, with a building in which the one or more window related device(s) are installed, or at least a part thereof, such as e.g. an apartment.

The invention may moreover relate to a set of components, which set comprises an adjustable window related device and a system, wherein the system is configured for controlling the adjustable window related device according to one or more of claims claims 1-23. This may e.g. provide a solution where the adjustable device such as for example a window sold together with a screening device (and/or where a screening device is sold alone) is configured so that the screening device and/or window will be operated according to an obligatory control scenario when installed in a building.

### BRIEF DESCRIPTION OF THE DRAWINGS

The invention will be explained in further details below with reference to among others the figures of which:

FIGS. 1-2: illustrates embodiments of a system according to embodiments of the invention,

FIG. 3: illustrates an embodiment relating to overruling an obligatory control scenario according to embodiments of the invention,

FIG. 4: illustrates an embodiment relating to controlling a device according to time data according to embodiments of the invention

FIG. 5: illustrates an embodiment relating to a more advanced controlling of one or more devices according to embodiments of the invention,

FIG. 6: illustrates an embodiment relating to controlling a device according to a parameter relating to daylight according to embodiments of the invention,

FIG. 7: illustrates embodiment relating to using a plurality of obligatory control scenarios according to embodiments of the invention,

FIGS. 8-9: illustrates embodiments relating to controlling a plurality of devices according to embodiments of the invention,

FIG. 10: illustrates embodiments relating to further embodiments of controlling devices, according to embodiments of the invention,

FIG. 11: illustrates embodiments relating to an operating according to safety criteria, according to embodiments of the invention,

FIG. 12: illustrates embodiments relating to operating a plurality of devices where some devices provide heat management according to an obligatory control scenario while other devices have been subjected to user initiated actions, according to embodiments of the invention, and

FIG. 13: illustrates an embodiment of an arrangement/circuitry according to embodiments of the invention.

### DETAILED DESCRIPTION

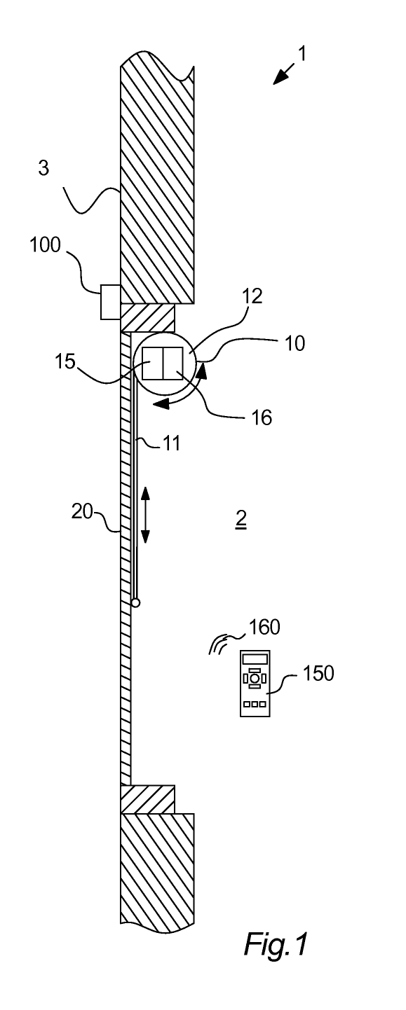

FIG. 1 illustrates an embodiment of the system 1 according to embodiments of the invention. The figure illustrates an example of an embodiment of the system 1 for operating an adjustable window related device. In FIG. 1, the adjustable window related device is a screening device in form of a blind 10, in this embodiment it is a roller blind, but it is understood that the window related device may also be the window 20, or other types of screening devices such as awnings, venetian blinds, shutters, film coatings that may change transparency according to a control signal and/or the like.

The roller blind 10 comprises a sheet 11 of material such as a fabric or another material for being winded and unwinded on a drum 12, and according to how much the sheet is unwinded, the inflow of sunlight through the window 20 into the room 2 during the day may be adjusted. Also, according to how much the sheet is unwinded, the degree of insulation provided by the blind 10 may be adjusted. Thus, outflow of cold or heat from the room 2, through the window 20 may as well be adjusted by controlling the blind.

Thus heat gain in rooms 2 of the building 3 may be controlled so as to e.g. reduce and/or increase heat gain in the building 3 by adjusting the blind 10.

The system 1 comprises a controllable unit 15 which is associated with the blind 10, and an adjustment device 16 in the form of an electric motor for adjusting the window related device based on input from the controllable unit 15.

The adjustment device 16 and the controllable unit may be battery operated and may thus comprise a battery (not illustrated) to provide electric power to the adjustment device 16, the controllable unit, a data input unit 100 and/or the like. Alternatively or additionally, the adjustment device 16, controllable unit and/or data input unit 100 may be arranged to be provided with electric power from a power output providing power from the utility grid.

The system 1 moreover comprises a data input unit 100 for providing data that may form basis for controlling the blind. The input unit 100 may comprise a timer functionality, it may comprise an indoor and/or outdoor temperature sensor, it may comprise a light sensor such as a sunlight/daylight sensor and/or the like.

In embodiments of the invention, the system may also comprise a rain sensor that may provide a parameter to assure that an adjustable device 10, 20, 30 is adjusted if it rains. This may e.g. be relevant in relation prevent opening e.g. windows in the event that it rains.

The system 1 is configured to control the blind based on an obligatory control scenario. The obligatory control scenario comprises one or more rules which may be based on input from one or more data input units 100. The system 1 provides heat energy management in the building 3 in which the adjustable window related device (in the present example the blind 10) is arranged by adjusting the window related device 10 according to the obligatory control scenario.

The battery may in embodiments be recharged by a solar cell for converting energy provided by sunlight into electrical energy. Such a solar cell may in embodiments of the invention also be a data input unit 100 for detecting presence of sunlight which is not reduced by clouds covering the sun, e.g. by detecting the amount of energy provided by sunlight.

The obligatory control scenario is configured to be allowed to be temporarily at least partly overruled based on user initiated actions, but will be re-introduced later on to provide the heat energy management.

It is generally to be understood that the heat energy management provided by the obligatory control scenario(s) may also in this document be referred to as “heat management”

The user initiated actions may e.g. comprise that a user operates a remote control 150 of the system 1 so as to e.g. wind the sheet 11 onto the drum 12, thereby allowing more light to enter into the room 2. A user hence presses a button or a touch screen on the remote control 150, and the remote control then transmits a control signal 160 to e.g. the controllable unit 14 to operate the blind 10. The system may, instead of the remote control, or as an addition to the remote control 160, comprise an up/down button arranged e.g. at or near the controllable unit 15 for operating the blind 10.

The system 1 generally comprises data storage(s), data processing unit(s) (also known as CPU (central processing unit)), data communication means and/or the like to provide the processing of parameters from input units, the rules of the obligatory control scenario, user initiated actions and/or the like. The data processor(s) may hence e.g. be arranged to provide output assigned to adjustable devices based on processing of e.g. the rules of the obligatory control scenario stored in a data storage, input from data input unit(s) of the system and/or user initiated actions provided by e.g. a remote control or another controller.

Embodiments of the obligatory control scenario and the input unit(s) are described in more details on below.

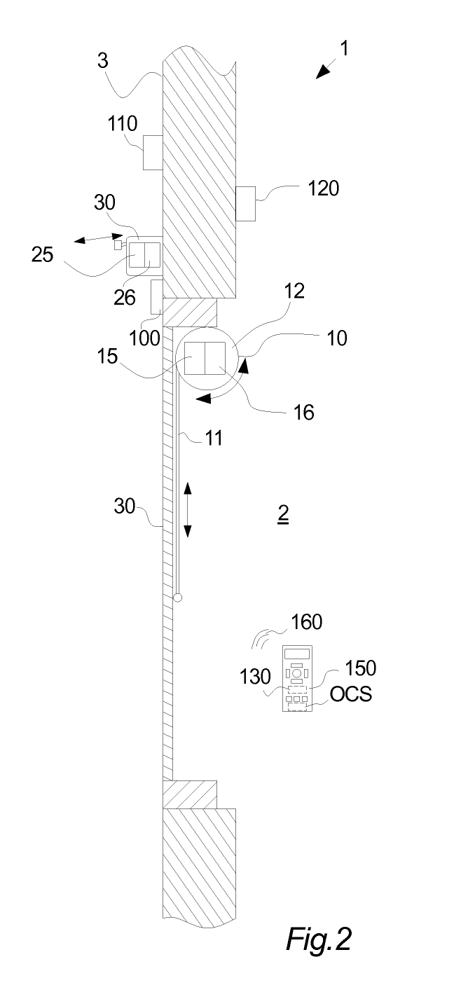

FIG. 2 illustrates an embodiment of the system 1 according to embodiments of the invention where the system comprises a plurality of data input units 100, 110, 120, 130.

The system 1 hence comprises a first data input unit in the form of a sensor 100 for detecting the amount of sunlight/daylight present at the window 20.

Moreover the system comprises a temperature sensor 110 for detecting the outside temperature, and a temperature sensor 120 for detecting the temperature in the room 2 where the window 20 provides light from the outside of the building 3.

Additionally, the system 1 comprises a further data input unit 130 for providing a timer functionality to the obligatory control scenario. In the example, the data input unit 130 is arranged in the remote control 150, but may in other embodiments be arranged in or together with e.g. the controllable unit 15 or at another location. Different examples of the operation of the obligatory control scenario OCS is described below.

It is understood that the system 1 in further embodiments may comprise more or fewer data input units. For example, the system 1 may in embodiments comprise the data input unit 130 providing the timer functionality as the only data input unit, it may comprise just the sensor 100, it may comprise a combination of the sensor 100 and/or the timer functionality provided by the data input unit 130 together with e.g. the temperature sensor 120 and/or 110. Also, it is understood that the system 1 may be upgraded over time from e.g. only comprising the data input unit 130 and/or the sensor 100. E.g. so that it also comprises e.g. the temperature sensor(s) 110, 120. Thus, the obligatory control scenario OCS may be amended or replaced with another obligatory control scenario OCS over time dependent on which data input units that are available for providing parameters that may be used for rules of the obligatory control scenario OCS.

In the present example, the remote control 150 may comprise a data storage and a data processor (not illustrated) for storing and executing the obligatory control scenario. For example, in the event that the window 20 or the screening device 10 is delivered from the manufacturer with a remote control, it may be advantageous to implement the processing of the obligatory control scenario OCS in the remote control 150. However, in other embodiments, the obligatory control scenario OCS may be stored and executed at other locations in the system 1. For example, the obligatory control scenario OCS may be stored and executed/processed in/at the controllable unit 15 or in another device such as a docking station or a further receiver (not illustrated) or the like of the system 1.

The obligatory control scenario OCS comprises a set of rules which enables the obligatory control scenario OCS to perform heat energy management in the building 3 based on input from the data input unit(s).

For example, the obligatory control scenario OCS may define a target temperature for the room 2, e.g. dependent on the time on the day (may be controlled by the data input unit 130). For example, if the target temperature for the room 2 is higher than the room temperature detected by the room temperature sensor 120, the obligatory control scenario may assure that the blind 10 is winded to be rolled up so that maximum of sunlight can enter the room 2 through the window 20, thereby inducing a heat gain in the room 2.

As another example, if a target temperature for the room 2 is higher than the room temperature detected by the room temperature sensor 120, the obligatory control scenario may assure that the blind 10 is unwinded to be rolled down so that a reduced amount of sunlight can enter the room 2 through the window 20, thereby reducing a heat gain in the room 2.

The above may also be achieved by controlling a screening device in the form of an awning 30. The awning may be controlled by an adjustment device 26 such as an electric motor and a controllable unit 25.

Also, the above may be achieved by providing a control to the window 20. Thus, if the detected room temperature is higher than the target room temperature, and a temperature sensor 110 for detecting the outside temperature detects that the outside temperature is lower than the temperature in the room 2, the obligatory control scenario may provide instructions to a controllable unit to open the window 20 a predefined amount. The window 20 may thus be controlled by a controllable unit and an adjustment device which are however not illustrated in FIG. 2. The opening of the window may e.g. in embodiments of then invention be based on the temperature difference between the detected room temperature and outside temperature and/or the difference between the detected room temperature and the target room temperature. Thus, the bigger temperature difference, the more the window is opened and vice versa.

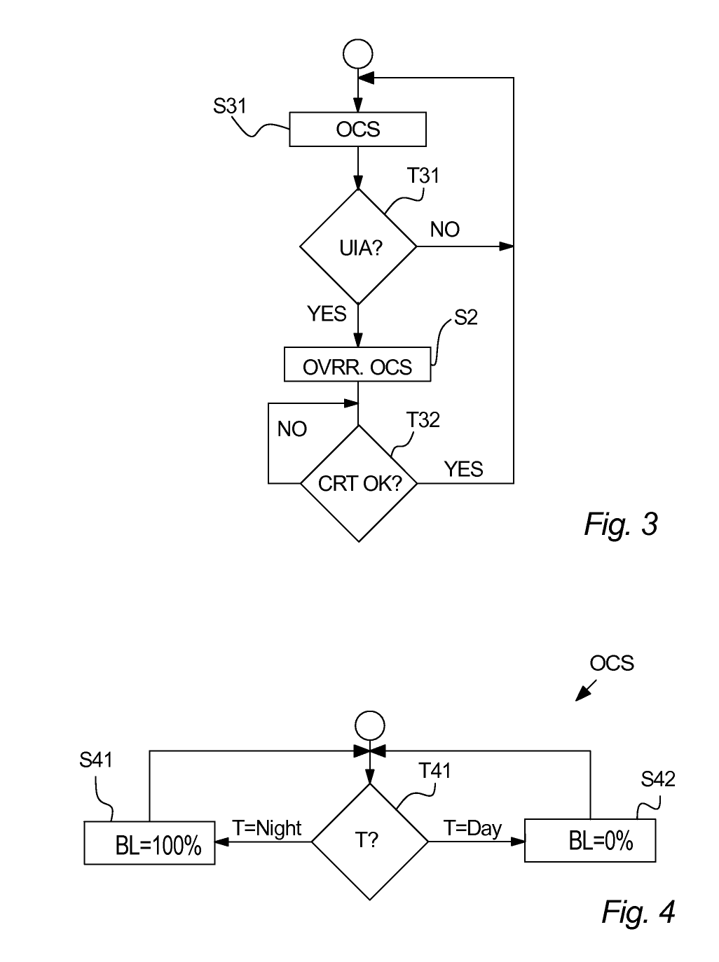

FIG. 3 illustrates an embodiment of the operation of the obligatory control scenario OCS, where user initiated actions UIA temporarily overrules the obligatory control scenario OCS.

At startup, the system 1 automatically enables (step S31) the obligatory control scenario OCS to provide heat management in the building 3. A user may then at some point wish to overrule the obligatory control scenario OCS so that e.g. more light from outside the building enters a window. Thus, the user may operate a remote control or the like of the system 1 to roll up/adjust a blind, wind an awning or the like. If such user initiated actions UTA are provided (test T31), the system temporarily overrules the obligatory control scenario OCS so that the instructions to amend the adjustment of a window related device is accepted temporarily (step S2) although the instructions are against the provisions of the obligatory control scenario OCS.

The system 1 then tests whether criteria for returning to the obligatory control scenario OCS are fulfilled (test T32, CRT. OK?). These criteria may e.g. comprise that a timer may be set upon the initiation of the temporary overruling of the obligatory control scenario, and when the timer expires, the system removes the overruling and thus return to operate according to the obligatory control scenario OCS. Another example of a criterion of test T32 may be that a movement sensor has detected that persons have not be present in the room 2 for a while. Further criteria for returning to operate according to the obligatory control scenario may be given by the rules of the obligatory control scenario.

Also, it is to be understood that if the system 1 for some reason is disabled for a while due to e.g. missing electric power or service on the system, the system 1 power powers up again so that the obligatory control scenario OCS is enabled.

FIG. 4 illustrates an example of an obligatory control scenario which is based on data input comprising information regarding the time on the day. For this purpose, a data input unit (not illustrated in FIG. 4) may provide time information so that the system can determine the time on the day.

For example, the system 1 may comprise a time schedule that comprises information of the time on the day, whether it is summer or winter time, and/or time definitions regarding when to define when to shift from day to night.

For example, this time functionality provided by the data input unit may comprise the information that at 23:00, the system should go into night mode, and at 07:00, the system should go into day mode. Alternatively or additionally, the time information may be controlled by a functionality where a user selects a geographical location of the system, in the system, and the system may then e.g. comprise preset times for when to enter day or night mode.

A user may in embodiments of the invention be able to influent when to shift between day mode ad night mode. For example, the user may in embodiments of the invention be able to set when the obligatory control scenario should enter night mode. However, in embodiments of the invention, this may be provided so that the system limits the user's possibilities regarding this so that the system e.g. may define a minimum predefined time span between day mode and night mode. So if for example the user defines that the night mode should be initiated at 23:00 PM, the system may define that there should be at least e.g. 7 hours between the entrance into night mode, and the return to day mode.

Hence, if the user defines that night mode should be initiated at 23:00 PM, the user may as the earliest time select that the obligatory control scenario should enter day mode at 06:00.

The obligatory control scenario OCS may, in embodiments of the invention moreover be set so that the shift between day mode and night mode is dependent on the day on the week. For example, the night mode may be entered at a later time in the weekends in that the occupants of the building may stay up later than from Monday to Friday. Also, the obligatory control scenario may in embodiments be set so that the shift to the day mode from the night mode is performed e.g. later at the weekends and/or at holidays and and/or other non-working days in that for example, people may meet at work later, if at all, at these days. This may be relevant in embodiments where the system 1 is implemented at e.g. a workplace such as an office, a factory for producing goods, a store and/or the like.

Hence, in FIG. 4, the obligatory control scenario receives information regarding the time on the day, or alternatively just a parameter representing whether it is day or night as e.g. explained above.

Hence, in FIG. 4, the system at test T41 detects whether to enter day or night mode. If the received information from the time functionality indicates that the system 1 should be in night mode, the, the system 1 may thus adjust one or more adjustable window related devices 10, 20, 30 according to the rules of the obligatory control scenario. So hence, e.g. a blind may be set to 100% (Step S41) so that it is in a substantially full covering position at night to substantially cover e.g. the whole window area to reduce heat from leaving the building by enhancing the degree of insulation. On the other hand, if the received information from the time functionality indicates that the system 1 should be in day mode, the obligatory control scenario may move the same blind to a substantially closed, non-screening position (step S42) so that sunlight may enter the room 2 so that e.g. increased heat thus may be provided.

The rules of the above mentioned scenario is also indicated below

If((Time = night))

{Blind1=(100%};

Else If (Time = day)

{Blind1= 0%};

It is however understood that if predefined user initiated actions UTA are detected, such as if a user wants to look out the window after the system have entered the night mode, the user may operate a remote control or another control to e.g. roll up the awning to be able to look out the window as e.g. described in relation to FIG. 3. Thus, the obligatory control scenario OCS may be temporarily overruled for a while, e.g. determined by a timer functionality or another functionality, and when this timer has expired, the system will initiate the obligatory control scenario OCS again so that the awning is moved to the full covering position again according to Step S41.

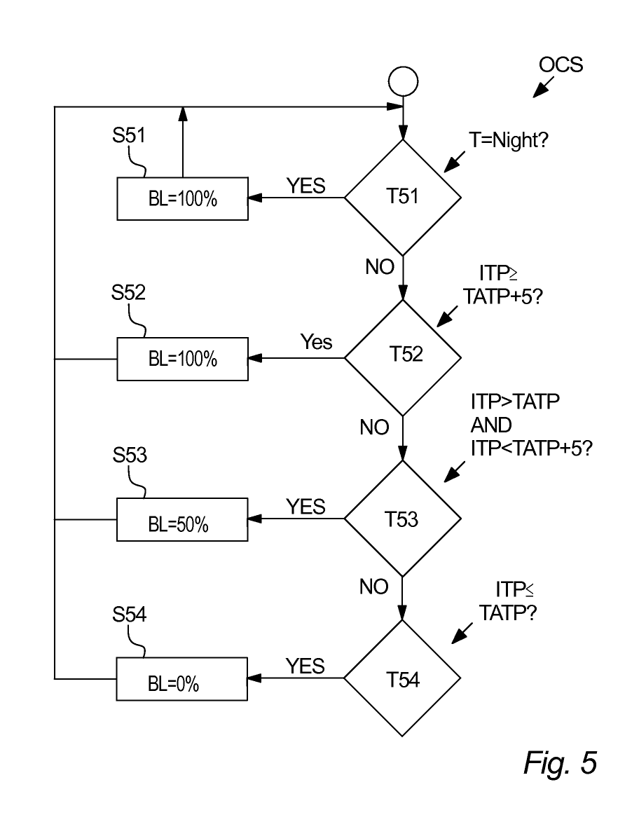

FIG. 5 illustrates a more complex obligatory control scenario OCS comprising a plurality of rules, where several parameters in the form of both temperature parameters and time parameters received from a plurality of data input units are used by the obligatory control scenario, and moreover where a graduated control of an adjustable window related unit is provided based on the received parameters.

At test T51, it is tested whether to enter night mode or day mode. Thus, a time functionality as described e.g. above may be used. If the time functionality indicates that it is night, the obligatory control scenario adjusts the blind BL to 100% so that it is in its substantially full covering/screening position. If it is however not indicated that it is night (i.e. day mode should be used), the obligatory control scenario may adjust the blind according to a measured temperature in a room which is provided with light through a window related to the blind.

This may be based on a target temperature TATP that is preset to a predefined temperature. For example, a user may indicate a target temperature of e.g. 21° C., 22° C., 23° C. or the like for the room, and this may be used as the target temperature for the obligatory control scenario during day when the system is in day mode.

Hence, the obligatory control scenario OCS may be set so that if the temperature in the room ITP is detected to be larger than or equal to the target temperature TATP+5° C. (test T52), the obligatory control scenario OCS adjusts the blind BL to a 100% screening position (step S52) to prevent as much heat from entering the room through the window.

According to test T53, if the temperature in the room is determined to be above the target temperature, but less than the target temperature +5° C., the obligatory control scenario may adjust the blind to a setting between about 0% and 100% covering/screening, such as e.g. 50% of its full covering position as illustrated in step S53.

If however, the room temperature ITP is about or below the predetermined target temperature TATP, (test T54), the obligatory control scenario OCS adjust the blind to a substantially open, non-screening position (Step S54) to help providing heat to the room 2 by sunlight, and/or to avoid screening the window without a rational heat management purpose in the event that the energy that may be provided due to sunlight is minimal due to e.g. clouds.

The adjustment of the blind may thus be provided by the controllable unit 15 controlling the adjustment device 16 so as to adjust the adjustable window related device in accordance with the rules of the obligatory control scenario OCS.

If (Time = night)

{Blind1=100%};

If ((indoor_temp > target_temp+5) AND (Time=day))

{Blind1=100%};

Else If ((indoor_temp > target_temp) AND
(indoor_temp ≦ (target_temp +5)) AND
(Time=day))

{Blind1=(50%};

Else If (indoor_temp ≦ target_temp AND Time=day)

{Blind1=(0%};

Else

{Blind1=0%};

The above may in embodiments of the invention also be controlled based on a parameter from a data input unit in the form of a sensor for detecting the amount of sunlight provided to the window. So if the sun shines from a substantially clear sky, the obligatory control scenario may determine to adjust the blind to a covering position in steps S52 and S53, but if the sun is covered by clouds, the steps T52, T53 may not be relevant in that it may have a limited effect on the room temperature to screen a part of the window, and hence, it may be more relevant to allow maximum daylight to enter the window to the room.

It is understood that the graduated control by using three or more different settings of the adjustable device based on a room temperature in embodiments of the invention may be omitted so that the system either adjusts the adjustable window related device to either a position being either 100% or 50% based on e.g. the temperature. Also, in further embodiments of the invention, even more different settings may also be provided based on the detected temperature such as e.g. from 0-100% with a 10% adjustment interval, from 0-100% with a 25% adjustment interval (i.e. a device setting of e.g. 0%, 25%, 50%, 75%, 100%) and/or the like. Also, other intervals may be used.

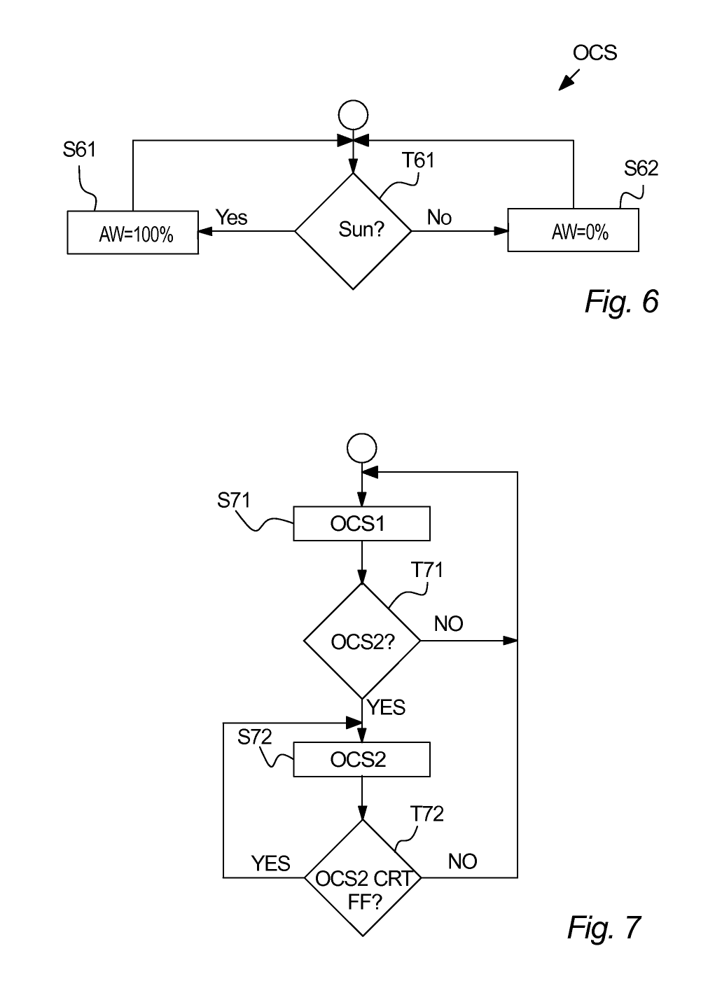

FIG. 6 illustrates another example of an obligatory control scenario OCS which is substantially similar to FIG. 4. However this obligatory control scenario OCS is based on detection of sunlight/dayight. If the system 1 comprises a data input unit in the form of a sensor for detecting the presence and/or the amount of sunlight, this information may be used as a parameter in relation to the control by the obligatory control scenario OCS. The obligatory control scenario OCS may hence detect the amount of sunlight present at or near the window related to an adjustable window related device, for example an awning AW which is arranged above a window to screen the window from inflow of light through the window dependent on the setting of the awning.

Hence, in test T61, the sensor provides information to the obligatory control scenario OCS regarding whether e.g. the sun shines from a clear sky or if clouds covers the sun. This may e.g. be provided by a lux sensor, a solar cell for providing electrical energy to e.g. charge a battery powering a component of the system 1 (e.g. by detecting the amount of electric power provided by the solar cell) and/or the like.

If the amount of light detected is above a predetermined level, the system 1 determines that the sun shines from a clear sky, and thus, the awning should be extended (S61) to e.g. full screening position at about 100% extension or the like to prevent the sunlight from entering directly through the window. If, on the other hand, the amount of light detected is below a predetermined level, the system 1 determines that the sun does not shine from a clear sky, and thus, the awning should not be extended (S62), thereby allowing a larger view through the window and possibly also more daylight to enter the window.

The sensor for detecting the presence and/or the amount of sunlight may moreover in embodiments of the invention replace a time functionality as described above, and may hence be used for determining when it is day and when it is night, dependent on the detected amount of light outside the building.

It is to be understood that the obligatory control scenario OCS as described in relation to e.g. FIGS. 4 and 6 in embodiments of the invention may be considered as a first obligatory control scenario, and that the system 1 at a later point may be upgraded to a more advanced control scenario as e.g. described in relation to FIG. 5, where more parameters are used in relation to rules of the obligatory control scenario OCS. Also, it is to be understood that the embodiments disclosed in relation to e.g. FIGS. 4-6 may be combined,

Moreover, it is to be understood that the mentioned adjustable window related device(s) mentioned in relation to the embodiments disclosed in relation to e.g. FIGS. 4-6 may be substituted with other adjustable window related devices such as awnings, blinds, shutters, a film coating that may change transparency according to a control signal and/or the like.

It is also understood that the system 1 in embodiments of the invention may comprise a plurality of adjustable window related devices which are controlled according to an obligatory control scenario OCS. For example, the system may comprise an awning controlled in accordance with the embodiment of FIG. 6, and a blind controlled in accordance with the embodiments of FIG. 4 or 5. The awning and blind may thus relate to controlling screening of different windows, or they may be arranged to control screening of the same window, so that the same window may be screened by an awning as well as a blind. The obligatory control scenario OCS may thus in embodiments of the invention use e.g. the awning for providing heat energy management during the day, and the blind for providing heat energy management during the night.

FIG. 7 illustrates a flowchart relating to switching between different obligatory control scenarios OCS1, OCS2 according to embodiments of the invention. Upon power up, the system 1 initiate (Step S71) a first obligatory control scenario OCS1 providing heat energy management in a building by controlling one or more adjustable window related devices such as window(s), blind(s), shutter(s), film(s) for changing transparency according to a control signal and/or the like.

A user may then upgrade the system by providing a further controller, and/or upgrade the software of the system 1 so as to e.g. provide a more advanced and/or user friendly obligatory control scenario OCS2 that for example may be used for providing heat management in the building by controlling a plurality of adjustable window related devices. Hence, if a second obligatory control scenario OCS2 is detected in the system (test T71) the system 1 is arranged to operate according to the second obligatory control scenario OCS2 (step S72), so that the second obligatory control scenario takes over the heat management from the first obligatory control scenario OCS1.

To assure that the adjustable window related device(s) which are controlled by the system 1 is inevitably controlled by an obligatory control scenario OCS1, OCS2 providing heat energy management, the system 1 over time tests whether criteria for performing the heat energy management according to the second obligatory control scenario OCSs are complied with/fulfilled (test T72—OCS2 CRT FF)). If these criteria for operating according to a second obligatory control scenario OCS2 are complied with, the system continues with operating according to the second obligatory control scenario OCS2. However, if the criteria (test T72) are not complied with, for example that a controller providing the data processing and/or data storage for the second control scenario OCS2 is removed from the system 1, if a rule of the second obligatory control scenario OCS2 cannot be complied with or tested due to e.g. a data input unit providing parameters to the seconds obligatory control scenario OCS2 is removed from the system 1 or is out of order and/or the like, the system 1 switches to providing the heat management according to the first obligatory control scenario OCS1.

Hence, the system 1 may continuously provide at least a basic heat management by means of an obligatory control scenario OCS1, OCS2 even though they may be temporarily overruled.

The combination of a window 20 one or more adjustable window related devices 10, 20, 30 related to that window, and one or more controllable units 15 for controlling the adjustable window related device(s) 10, 20, 30 may also be referred to as a window arrangement. The window arrangement may moreover in embodiments of the invention comprise one or more data input units (100, 101, 102, 103) related to the respective window arrangement.

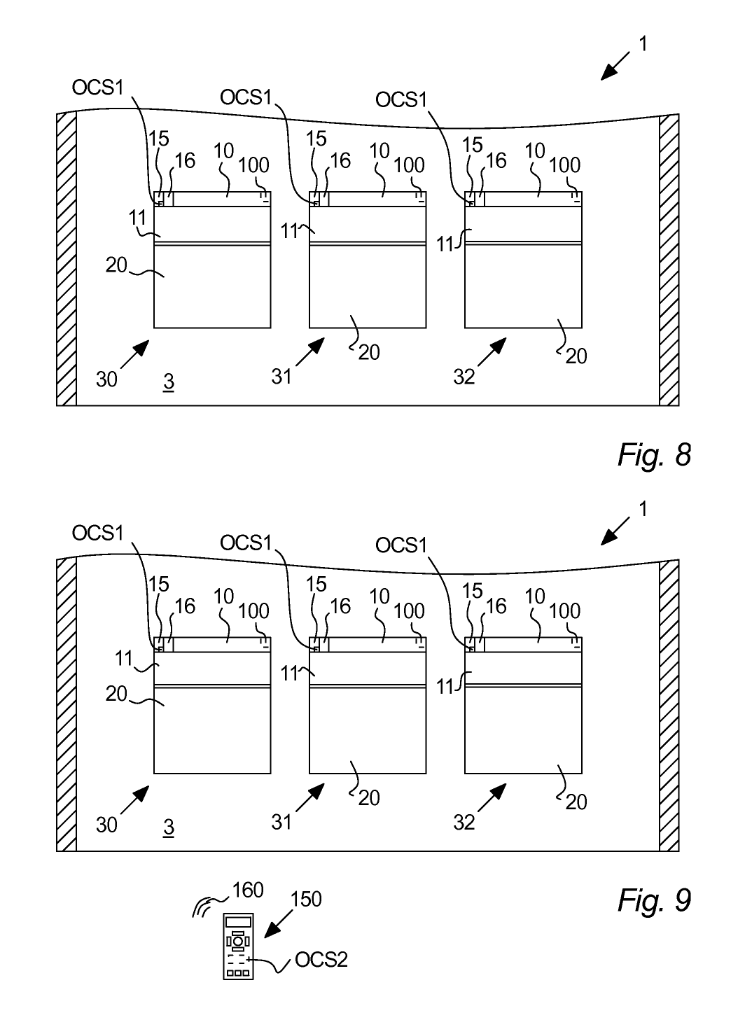

FIG. 8 illustrates an embodiment of the invention where a building 3 comprises a plurality of adjustable window related devices 10 (e.g. a blind as illustrated) related to each their window arrangement 30, 31, 32. These are controlled by each their controllable unit 15 of the system 1, which controls an adjustment device 16 to adjust the respective window related device 10.

As illustrated, obligatory control scenarios OCS1 are stored in a data storage associated with the respective controllable unit 15. The controllable unit 15 may thus comprise the data storage, or it may in other embodiments of the invention be stored in/at the adjustable device 10 or the like. The controllable units 15 may moreover comprise a data processor for executing the obligatory control scenario OCS1 related to the respective controllable unit 10.

As illustrated, in embodiments of the invention, data input units 100 such as a light sensor, a time functionality, a temperature sensor or the like may be associated to each window arrangement 30-32. In the present example, a light sensor 100 is described in relation to the obligatory control scenarios OCS1.

The obligatory control scenarios OCS1 of the respective window arrangement 30-32 are configured for operating each their window related device 10. Hence, the obligatory control scenario OCS1 related to the leftmost window (of the window arrangement 30) is configured for operating the window related device(s) of that window arrangement 30, the obligatory control scenario OCS1 of the window of the window arrangement 31 in the middle is configured for operating the window related device(s) associated with that window, and so on.

Hence, when the system 1 is installed and started, the adjustable window related devices 10 of the respective window arrangements 30-32 are in embodiments of the invention controlled by three substantially independent first obligatory control scenarios OCS1 based on data input from different data input units 10 related to e.g. the respective window arrangement 30-32.

This may be acceptable in many situations, but in further situations according to further embodiments of the invention, it may be relevant to provide a solution where a further second obligatory control scenario OCS2 may take over the heat energy management provide by the obligatory control scenarios of the respective window arrangements 30-32.

Such an embodiment is illustrated in FIG. 9 wherein a control unit 150 is configured for providing heat management by a second control scenario OCS2. The control unit may be a remote control comprising a data storage and processing means (not illustrated) for storing and processing the second obligatory control scenario OCS2, and transmitting wireless control signals 160 to the controllable units 15 based thereon. The second obligatory control scenario OCS2 is hence common to a plurality of window arrangements 30-32, and thus provides heat management to the room(s) of the building 3 by controlling the controllable units 15 and thus the adjustable window related devices 10 related to a plurality of windows of the building 3.

To e.g. provide a more synchronous operation of the devices 10, the control unit 200 may comprise it's own data input unit (not illustrated) such as a temperature sensor and/or a time functionality, and/or it may receive parameter from one or more data input units (10) of the window arrangements (10). Hence, in embodiments of the invention, the window related devices 10 of the window arrangements 30-32 may be controlled by a common second obligatory control scenario OCS2 based on a sensor or another data input unit that is considered common for a plurality of window arrangements 30-32. In embodiments of the invention, parameters from one or more data input units 100 of e.g. the window arrangements 30-32 may be disregarded during the control by the second obligatory control scenario OCS2. Hence, for example only the data input unit 100 related to the first window arrangement 30 is used for e.g. providing time indications or daylight information while the parameters from the data input units related to the window arrangements 31, 32 may be disregarded.

However, in embodiments of the invention, if e.g. the control unit 150 e.g. is removed from the system 200, if the control unit 150 runs out of battery (in embodiments where the control unit is battery powered), if a data input unit 100 providing parameters to the control scenario OCS2 is removed from the system 1 and/or runs out of battery in the event that it is battery powered and/or the like, the window arrangements 30-32 may be operated according to the different obligatory control scenarios OCS1 of the respective window arrangements 30-32. This may for example be provided in accordance with e.g. the embodiments described in relation to FIGS. 7 and 8.

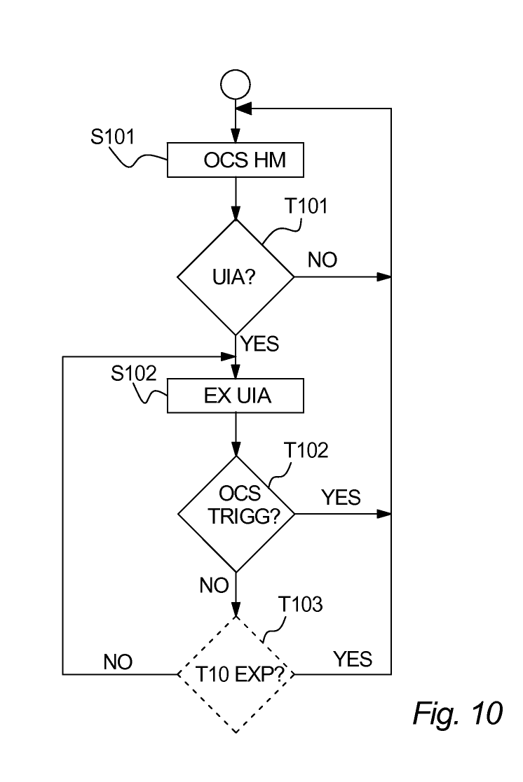

FIG. 10 illustrates a flow chart relating to an embodiment of the invention wherein the system 1 is configured so that an obligatory control scenario (or at least parts thereof) is still processed while it is overruled due to for example a user initiated action UIA.

In FIG. 10, an obligatory control scenario OCS (e.g. a first or second control scenario OCS1, OCS2) is initially enabled step (S101, OCS HM) so as to provide heat management in a building comprising one or more adjustable, window related devices controlled by the system 1.

If a user initiates a user initiated action (test T101, UIA?) by e.g. operating a controllable unit of the system 1 by means of e.g. a manual setting of the window related device, a setting by means of a user controllable control device such as a wireless remote control 150, a wired or wireless button arrangement connected to the controllable unit and/or the like, the obligatory control scenario OCS is temporarily overruled (step S102, Ex. UIA) so that the user may set the adjustable window related device to another setting than the obligatory control scenario OCS prescribes. The user may thus e.g. open the window, adjust an awning, a blind, shutters, a film coating with adjustable transparency and/or the like.

However, the obligatory control scenario OCS is still executed in the system 1 so that the system 1 tests (Test T102, OCS TRIGG?) whether trigger criteria based on e.g. parameters from data input unit(s) result in that a setting of an adjustable window related device should be changed according to the rules of the obligatory control scenario OCS. This test T102 may thus provide basis for determining whether to return to the heat management provided by the obligatory control scenario OCS. Hence, if the test is positive, e.g. because a temperature in a room raises to a level above a target temperature, if a time indication provides information regarding change from day to night mode and/or the like, the obligatory control scenario OCS is reintroduced. Otherwise, the user setting of step S102 may be allowed to remain.

FIG. 10 moreover illustrates an optional embodiment wherein a timer T10 may be set, e.g. triggered by the user initiated action UIA of step S102. This timer T10 may provide an assurance that the system 1 will return to provide heat energy management according to the obligatory control scenario OCS, e.g. upon expiry of the timer (test T103). For example even though the test T102 is negative in the sense that no adjustment changes should be provided by the obligatory control scenario OCS compared to the settings provided by the OCS before the user initiated actions were imposed, the timer may assure that the obligatory control scenario is reintroduced later on to provide heat energy management.

In embodiments of the invention, the timer T10 may also comprise a watchdog timer or another timer function that assures that the system inevitably will return to operate adjustable window related devices based on the obligatory control scenario to provide heat energy management. Such a watchdog timer may naturally be implemented in any suitable way to provide the above return to assure that the heat energy management will be provided. The timer 10 may in embodiments of the invention automatically be reset every time it expires. The timer may for example restart the obligatory control scenario OCS so user initiated actions are set aside. Such restart may take place at least every day, say when 24 hours have passed from a user initiated action or at a fixed time like every midnight.

As an example in relation to FIG. 10 the obligatory control scenario OCS may be overruled by a user that initiates an action to control a blind to be set to e.g. 50% screening even though the rule(s) of the obligatory control scenario OCS prescribes that the blind should be moved to 0% screening so as to provide maximum heat gain by sunlight. The obligatory control scenario OCS may however receive input from a data input unit such as a time functionality or a daylight sensor which indicates that the system, according to the provisions of the obligatory control scenario OCS should enter night mode. The rules of the OCS may thus define that the blind should be moved to 100% screening to improve insulation of the building at night. Thus, this may trigger (T102) that the obligatory control scenario OCS is re-enabled and hence moves the blind to a 100% screening position (e.g. together with other blinds for covering other window).

In embodiments of the invention, the obligatory control scenario(s) may be factory pre-set and becomes becoming active upon first power up of said system 1. Hence, when the system 1 is installed in a building, it may from the start provide heat energy management by means of an obligatory control scenario OCS, OCS1, OCS2, e.g. as described above. This may also in embodiments of the invention be provided if the system 1 is arranged to be retrofitted to adjust a window, awning, blind or the like already installed in a building.

In embodiments of the invention, the obligatory control scenario(s) OCS, OCS1, OCS2) may be temporarily at least partly overruled if predefined safety criteria are violated, and the system may then enable the obligatory control scenario when the predefined safety criteria are fulfilled.

For example, the system 1 may comprise an input unit in the form of a force measurement device (not illustrated) for detecting the amount of force needed provided to adjust an adjustable window related device. For example if the adjustable window related device is a window 20, the force measurement device may provide information regarding the needed force to close the window. If the parameter provided by this device indicates that a large force is applied (above a predefined level for example), and the window is still not closed, this may indicate that a person is stuck at the window, and this may trigger that the obligatory control scenario OCS, OCS1, OCS2 is temporarily overruled or disabled. However, the obligatory control scenario OCS, OCS1, OCS2 is enabled/introduced later on again when the safety criteria allows it.

As another example a controllable unit 15, 25 and a related adjustment device 16 may be powered by battery. The system 1 may additionally comprise a battery indicator related to the battery, and the above mentioned predefined safety criteria may hence relate to an input from the battery indicator. Thus, the obligatory control scenario may in embodiments of the invention be temporarily overruled if the battery indicator provides a low battery indication, to assure that there may be enough power for operating the adjustment device in e.g. emergency situations. However, when the battery indicator indicated that sufficient power is available again, e.g. due to that the battery is recharged by a solar cell or due to that the battery is replaced with another battery, the obligatory control scenario OCS is enabled again.

An embodiment of the above embodiments relating to predefined safety criteria is illustrated in the flowchart of FIG. 11.

Initially, the system 1 is operated according to an obligatory control scenario OCS (step S111). The system 1 then tests whether safety criteria are violated (test T111, SCV?). If the safety criteria are violated, the obligatory control scenario OCS may be overruled (step S112), but when the safety criteria are complied with again (test T112) the obligatory control scenario OCS is enabled again to provide the heat energy management. The safety criteria may relate to information from a battery indicator, an alarm signal from an external alarm system (not illustrated), a sensor for detecting whether an adjustable device is stuck and/or other relevant safety criteria.

To prevent that users are able to permanently disable the obligatory control scenario(s) OCS1, OCS2, OCS, the system 1 may be arranged with safety precautions so that this is only possible by entering a predefined code by a remote control, it may comprise the need of activating a hidden button in the remote control, a controllable unit and/or the like, it may comprise the need of opening a casing of the system 1 and remove or adjust a jumper for bypassing or enabling a part of an electronic circuit of the system and/or the like. Also, the system 1 may in embodiments of the invention simply be arranged so that the obligatory control scenario OCS, OCS1, OCS2 cannot be permanently disabled.

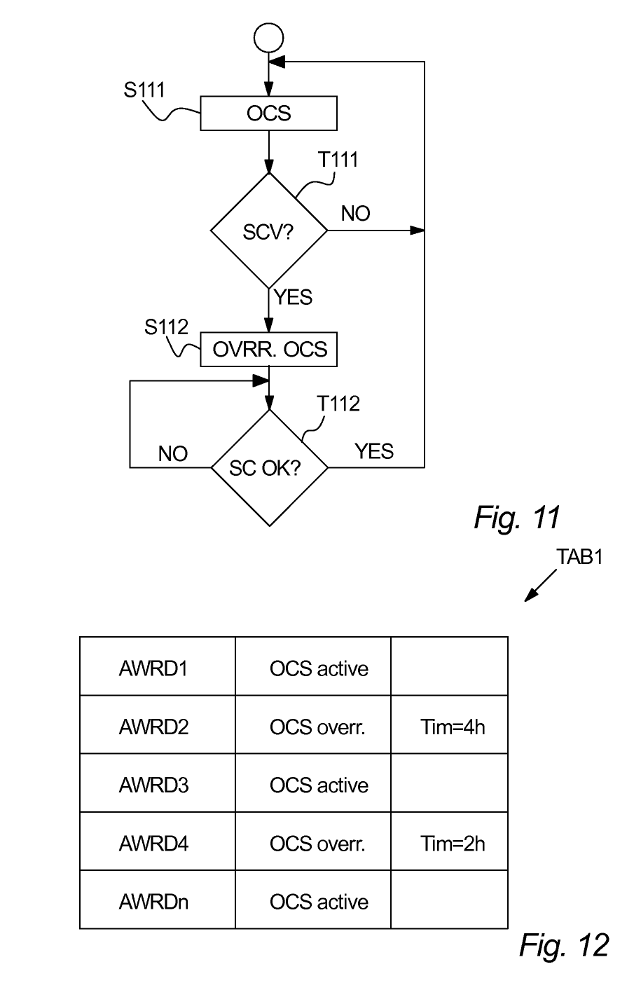

FIG. 12 illustrates an example of managing overruling of an obligatory control scenario OCS. The system 1 may be configured for controlling a plurality of adjustable window related devices 10, 20, 30. These are in FIG. 12 illustrated in a table Tab1 by references AWRD1-AWRDn which are all controlled by an obligatory control scenario OCS. The adjustable window related devices may individually be adjusted by a user providing a user initiated action which overrules the obligatory control scenario OCS as e.g. described above. In the present example, the second and fourth adjustable window related devices AWRD2, AWRD4, have been subjected to such a user initiated action UIA. For example, the second adjustable window related device AWRD2 may be a first window which the user has opened, and the fourth adjustable window related device AWRD4 may be an awning which the user has rolled out to screen sun light from entering a second window.

The remaining adjustable window related devices AWRD1, AWRD3, AWRDn are hence stilled operated to provide heat energy management of the building 3 according to the obligatory control scenario(s) OCS. In this example, a return criteria for the second and fourth adjustable window related devices AWRD2, AWRD4 is a timer which, when expired, induces that these adjustable window related devices AWRD2, AWRD4 return to be operated according to an obligatory control scenario(s) OCS, but also return criteria may also be used.

The embodiment(s) of FIG. 12 may for example be provided to embodiments of the invention wherein a common, second obligatory control scenario OCS2 is arranged to operate a plurality of window related devices 10, 20, 30, and or in embodiments where one or more first obligatory control scenario OCS1 are used to e.g. individually control different window related devices 10, 20, 30.

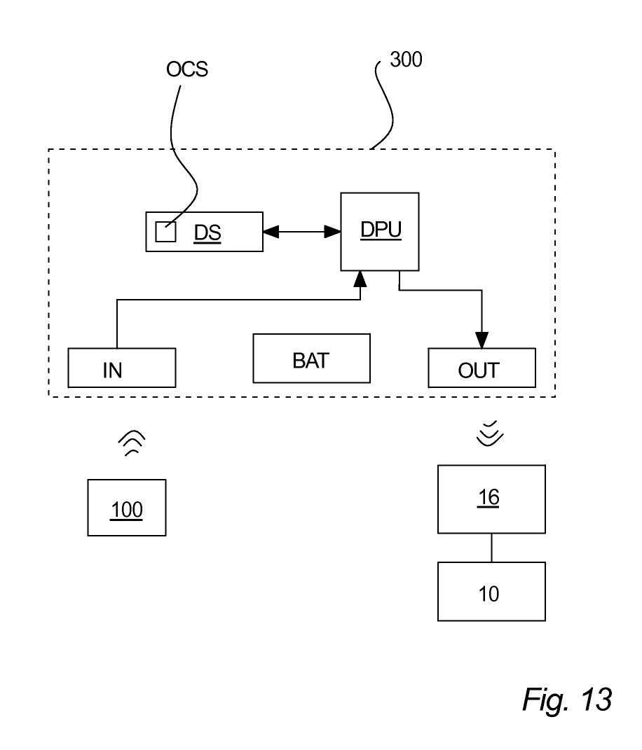

FIG. 13 illustrates an embodiment of an arrangement/circuitry 300 for providing control according to e.g. one or more of the embodiments disclosed above in relation to one or more of FIGS. 1-12.

The circuitry 300 comprises a data storage DS for storing the rules of the obligatory control scenario OCS. The data storage DS may comprise a solid state data storage (SSD), a random access memory (RAM) storage and/or any other suitable type of data storage. Moreover, the circuitry 300 comprises a data processing unit DPU such as a central processing unit (CPU) or another suitable type of data processor. The data processor is configured to process the rules of the obligatory control scenario OCS, and does so based on input from one or more data input units 100 such as a sunlight sensor, a time functionality, a temperature sensor and/or the like as e.g. explained above. Such signals may be wired or wirelessly received by a data communication facility IN of the circuitry 300. The information from the data input unit 100 is by the processor DPU processed according to the rules of the control scenario OCS, and output to control adjustable window related devices 10 may be transmitted (wired or wirelessly) by a data communication facility OUT to adjustment devices 16 based thereon, so as to provide the heat energy management according to the obligatory control scenario.

The circuitry 300 may e.g. be arranged to be a part of a controllable unit as explained previously, it may be arranged to be a part of a remote control, it may be arranged to be a part of a stand-alone device (for e.g. providing an obligatory control scenario to an existing system which is not in itself capable of handling an obligatory control scenario) and/or the like.

In the example of FIG. 13, the circuitry 300 is powered by battery BAT. This battery provides sufficient electric energy to the circuitry so that the OCS can be processed, signals from input unit(s) may be received and processed, and commands may be communicated to adjustable units. The battery BAT may be recharged by a solar cell of the system 1, it may be recharged from mains (for example if the circuitry is arranged in a remote control that may be arranged in a docking station for recharge) and/or the like. The battery may naturally also in embodiments just be exchanged when the battery is low on power. In other embodiments, the circuitry may also be connected to mains and may hence not be provided with main power from batteries, even though a backup battery in embodiments of the invention may be relevant to provide temporary electric energy to e.g. provide safety.

It is generally understood that the invention is not limited to the above examples but may be combined in a multitude of varieties as specified e.g. in the claims. Additionally, it is understood that different embodiments of the figures and/or the description above may be combined to obtain further embodiments. Hence it is understood that the system 1 may comprise one or a plurality of controllable units, data input units, remote controls and/or the like, and may be configured for controlling one window related device as well as a plurality of adjustable window related devices related to the same or different windows. This control may be provided by one or more of the embodiments as well as by any suitable combination of embodiments described in relation to FIGS. 1-12.

1. A method of operating a system for operating one or more adjustable window related devices,
wherein said system comprises:
one or more controllable units associated with said one or more adjustable window related devices, and
at least one data input unit,
wherein said one or more controllable units operates said adjustable window related device according to an obligatory control scenario,
wherein said obligatory control scenario comprises one or more rules, and wherein at least one of said one or more rules are based on input from said data input unit,
wherein said system provides heat energy management in a building in which said adjustable window related device is arranged by adjusting said adjustable window related device according to said obligatory control scenario, and
wherein said obligatory control scenario is temporarily at least partly overruled based on user initiated actions.

2. The method according to claim 1, wherein said system comprises a user controllable control device, and wherein said obligatory control scenario is temporarily at least partly overruled due to user input provided by means of said user controllable control device.

3. The method according to claim 1, wherein said obligatory control scenario is temporarily at least partly overruled if predefined safety criteria are violated, and
wherein said system enables said obligatory control scenario when said predefined safety criteria are fulfilled.

4. The method according to claim 3, wherein said controllable unit is powered by battery, wherein said system comprises a battery indicator related to said battery, wherein said predefined safety criteria relates to an input from said battery indicator, and wherein said obligatory control scenario is temporarily overruled if said battery indicator provides an indication of low battery.

5. The method according to claim 1, wherein at least a part of said obligatory control scenario is executed while it is overruled.

6. The method according to claim 1, wherein said at least one data input unit provides a time indication, e.g. based on a time schedule, and wherein said heat energy management is configured to be based on said time indication.

7. The method according to claim 1, wherein said overruling of said obligatory control scenario is removed upon expiry of a timer function.

8. The method according to claim 1, wherein said heat energy management reduces heat gain in said building based on input from said at least one data input unit by adjusting one or more of said one or more adjustable window related device(s) according to said obligatory control scenario rules.

9. The method according to claim 1, wherein said obligatory control scenario increases heat gain in said building based on input from said at least one data input unit by adjusting one or more of said one or more adjustable window related device(s) according to said obligatory control scenario rules.

10. The method according to claim 1, wherein said obligatory control scenario is factory pre-set and becomes active upon first power up of said system.

11. The method according to claim 1, wherein said adjustable window related device is a screening device.

12. The method according to claim 1, wherein said system comprises a plurality of controllable units, wherein said controllable units are associated with different adjustable window related devices, and wherein said plurality of controllable units are operated according to an obligatory control scenario.

13. The method according to claim 12, wherein said building comprises a plurality of windows, and wherein said different adjustable window related devices, are associated to different windows of said plurality of windows.

14. The method according to claim 1, wherein said obligatory control scenario is an automatic control algorithm.

15. The method according to claim 1, wherein said obligatory control scenario is temporarily and manually at least partly overruled based on user initiated actions.

16. Method according of claim 1, wherein the method is applied to obtain a tax advantage by automatically controlling one or more controllable units associated with said one or more adjustable window related devices.

17. A system for operating an adjustable window related device,
wherein said system comprises:
at least one controllable unit for being associated with an adjustable window
related device, and
at least one data input unit,
wherein said at least one controllable unit is configured to operate said adjustable window related device according to an obligatory control scenario,
wherein said obligatory control scenario comprises one or more rules, and wherein at least one of said one or more rules are based on input from said data input unit,
wherein said system is configured to provide heat energy management in a building in which said adjustable window related device is arranged by adjusting said adjustable window related device according to said obligatory control scenario, and
wherein said obligatory control scenario is configured to be temporarily at least partly overruled based on user initiated actions.

18. The system according to claim 17, wherein said system comprises a plurality of a controllable units, wherein said controllable units are configured to be associated with different adjustable window related devices, and wherein said plurality of controllable units are operated according to said obligatory control scenario.

19. The system according to claims 17, wherein said adjustable window related device is a screening device.

20. The system according to claims 17, wherein said system comprises at least one user controllable control device, and wherein said obligatory control scenario is configured to be temporarily at least partly overruled due to user input provided by means of said user controllable control device.

21. A method of improving heat energy management of a building, said method comprising:
providing a system according to claim 19 to said building,
associating one or more controllable units of said system with one or more adjustable window related device(s), and
associating said one or more adjustable window related device with a window of said building so that said system is able to provide said heat energy management of a room of said building by adjusting said adjustable window related device according to said obligatory control scenario.

22. A method of operating a system for operating one or more adjustable window related devices,
wherein said system comprises:
one or more controllable units associated with said one or more adjustable window related devices, and
at least one data input unit,
wherein said one or more controllable units operates said adjustable window related device according to an obligatory control scenario,
wherein said obligatory control scenario comprises one or more rules, said obligatory control scenario being an automatic control algorithm controlling said adjustable window related devices automatically over time,
and wherein at least one of said one or more rules are based on input from said data input unit,
wherein said system provides heat energy management in a building, in which said adjustable window related device is arranged, by said one or more controllable units operating said adjustable window related device according to said obligatory control scenario, and
wherein said obligatory control scenario is temporarily and manually overruled based on user initiated actions.

23. A method of operating a system for operating one or more adjustable window related devices to obtain a tax advantage,
wherein said system comprises:
one or more controllable units associated with said one or more adjustable window related devices, and
at least one data input unit,
wherein said one or more controllable units operates said adjustable window related device according to an obligatory control scenario,
wherein said obligatory control scenario comprises one or more rules, and wherein at least one of said one or more rules are based on input from said data input unit,
wherein said system provides heat energy management in a building in which said adjustable window related device is arranged by adjusting said adjustable window related device according to said obligatory control scenario, and
wherein said obligatory control scenario is temporarily at least partly overruled based on user initiated actions.
and wherein the tax advantage is obtained through an improved degree of insulation with respect to heat transmission via a window associated with one or more of said adjustable window related device.
